(19) United States
(12) Patent Application Publication
(10) Pub. No.: US 2003/0184106 A1
(43) Pub. Date: Oct. 2, 2003

(54) Vehicular hardtop lifting yoke

(76) Inventor: Dennis J. Windecker, Colorado Springs, CO (US)

Correspondence Address: HANES & SCHUTZ, P.C., 102 S. TEJON ST., SUITE 800, COLORADO SPRINGS, CO, 80903, US

(21) Appl. No.: 10/109,968

(22) Filed: Mar. 29, 2002

(51) Int. Cl. B66C 1/16

(52) U.S. Cl. 294/81.5

(57) ABSTRACT

A handling yoke for clasping a removable vehicular hardtop, comprising,

a rigid elongated spinal member adapted for alignment with the longitudinal axis of the vehicle, front and rear spaced apart cross members attached perpendicularly to the spinal member, with a hardtop grasping anchor depending from each of the lateral ends of the front cross member and an elongated hook tray flexibly depending from the rear cross member and adapted to grasp the hardtop at a laterally central position above the rear window of the hardtop.

### FIELD OF THE INVENTION

The present invention relates to apparatus for clasping and retaining a removable vehicular hard top. The yoke of the present invention may be used in connection with a cable hoist to remove, store and replace a vehicular hardtop.

### BACKGROUND OF THE INVENTION

Removing and replacing a heavy and cumbersome vehicular hardtop has inspired the creation of a number of devices to assist in the effort. Such apparatus are disclosed in U.S. Pat. Nos. 4,576,542, 4,600,177 and 5,263,687. The latter two patents disclose devices comprising a flexible strap harness having hooks that are attached to the harness so as to engage the lower edges of the top. A hoisting mechanism is connected to the harness for raising the top from or lowering the top onto the vehicle. The apparatus disclosed in U.S. Pat. No. 4,576,542 comprises a “T” shaped hinged frame whose cross member is a cincture, girdling the ceiling portion of the hardtop with an perpendicularly connected lever arm that is attached at one of its ends to a hoist mechanism, with the other of the arm's ends bearing against the upper surface of the hardtop to maintain the top's equilibrium during lifting or lowering operations.

While all of these prior art devices will work for the particular type of vehicle top disclosed, the stability of the top during lifting and lower operations is questionable. Stability is important during the lifting operation to maintain proper control of the top, however it is vitally important when lowering the top onto the vehicle, when the ability to accurately place the top onto its attachment means is crucial. Furthermore, it is desirable to provide a lifting yoke that is applicable to more than one particular vehicle.

### SUMMARY OF THE INVENTION

The hardtop handling yoke of the present invention broadly comprises a rigid hanger pallet with a plurality of spaced apart depending anchors for grasping the top window edges of the lateral sides and the top window edge of the rear panel of a vehicular hardtop. The hanger pallet is provided with means for attachment to a hoist mechanism.

The hanger pallet comprises a longitudinal spinal member having front and rear cross members from which the lateral sides and rear anchors depend.

### DESCRIPTION OF THE DRAWINGS

FIG. 1 is a perspective view of the handling yoke poised for being lowered to grasp the hardtop of the vehicle illustrated below the yoke.

FIG. 2 is a perspective view of the handling yoke with the yoke's anchors attached to the top front and rear window edges of the hardtop, ready to lift the removable hardtop from the vehicle.

FIG. 3 is a perspective view of the removable hardtop being lifted by the handling yoke of the present invention from the vehicle to which it was attached.

FIG. 4 is a top exploded view of the handling yoke.

FIG. 5 is a fragmentary perspective view of the pallet's rear cross member and showing one of two attachments between the cross member and the depending rear anchor tray.

FIG. 6 is a view similar to that of FIG. 5 and including, in phantom lines, a showing the relevant rear structural elements of the removable hardtop to which the rear anchor tray of the handling yoke is attached. FIG. 6 is cross-referenced to the dashed circle of FIG. 4.

FIG. 7 is a cross sectional view taken along line 7-7 of FIG. 6.

FIG. 8 is a fragmentary perspective view of the left end of the pallet's front cross member and the associated depending anchor hook, with relevant structural elements of the hardtop shown in phantom. FIG. 8 is cross-referenced to the dashed circle of FIG. 4.

### DETAILED DESCRIPTION OF THE INVENTION

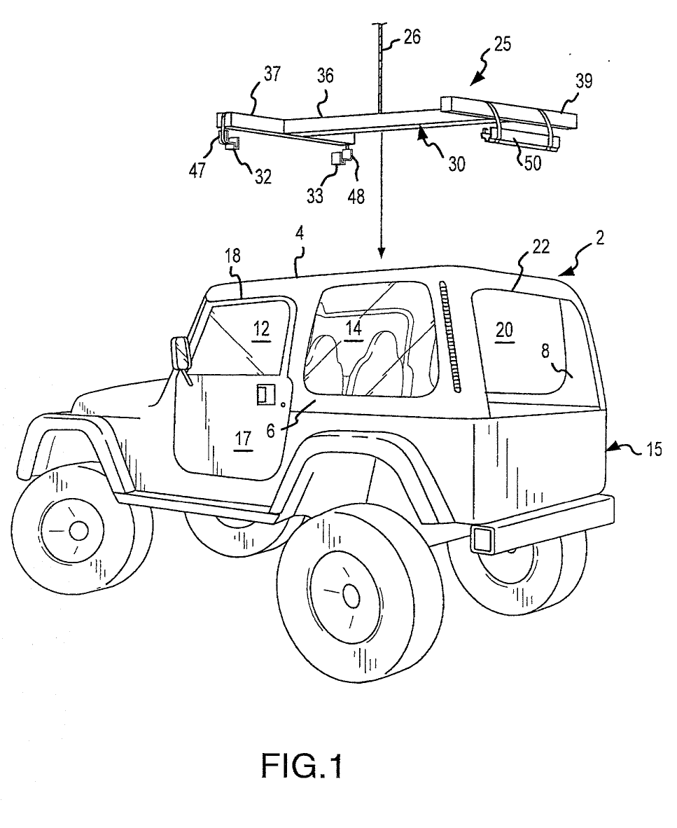

The preferred embodiment of the invention will be described in connection with a removable vehicle top 2, as shown in FIG. 1, although other models and designs of hardtops can be handled with the apparatus of the present invention. The hardtop comprises a top 4 with depending sides 6 and 8 and a depending rear portion 10. Forward of the depending sides 6 and 8 are spaces for the front side windows 12 and 14 of the vehicle 15 that are housed in the doors 17. Just above the top edge of each of the front windows there is a down turned edge 18 of the hardtop. A space 20 is provided in the rear panel of the hardtop 2 for a rear window. The lower edge 22 of a down turned rear portion of the top 4 of the hardtop defines the top edge of the window space 20.

The handling yoke 25 of the present invention is shown in perspective in FIG. 1, suspended by a hoist cable 26 above the removable top 2 to which the anchors of the yoke are to be flexibly attached for the purpose of lifting the top 2 from the vehicle 15 by means of a hoist and the hoist cable 26. The hoist is not shown because it may be of conventional design.

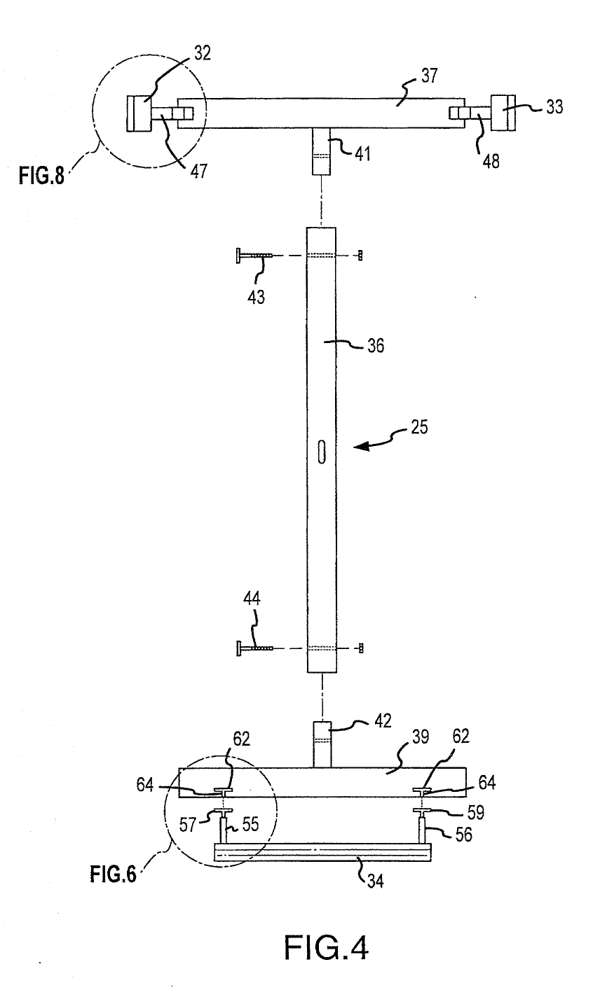

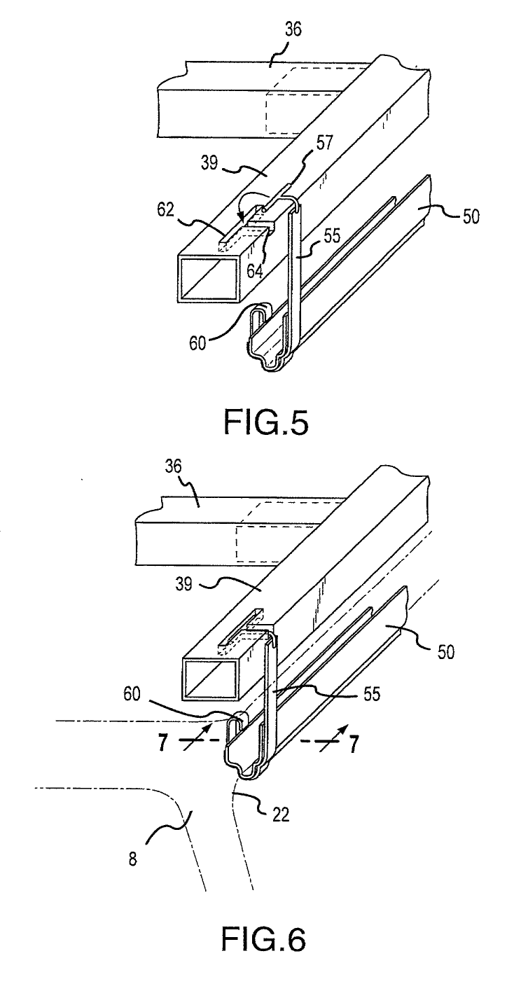

Referring to FIG. 4, the yoke 25 is seen to comprise a hanger pallet 30 and three flexibly depending anchors, 32, 33 and 34. The pallet 30 includes a rigid elongated spinal member 36 that is adapted to be aligned with the central longitudinal axis of the vehicle for grasping and lifting the hardtop 2. The top surface of the spinal members is equipped with a ring 38 for attachment of the hoist cable 26. Positioned at the respective forward and rear ends of the spinal member 36 are front and rear cross arms 37 and 39. For convenience of shipping and storage of the device, the cross arms are removably attached to the spinal member 36 by projecting studs 41 and 42 that are each secured at one of their ends to the respective cross arms and which telescopically fit into the interior of the tubing that comprises the spinal member 36. Pins 43 and 44 are insertable into aligned holes in the sides of the tubular spinal member and holes in the sides of the studs 41 and 42 to secure the cross arms 37 and 39 in place.

Anchors 32 and 33 are attached to the respective left and right lateral ends of the front cross arm 37. The anchors are preferably in the form of wide “J” shaped hooks that substantially conform to the profile of the down turned edge 18 of the top 4. Each of the “J”-like anchors 32 and 33 are connected to the cross arm 37 by means of flexible straps 47 and 48 respectively.

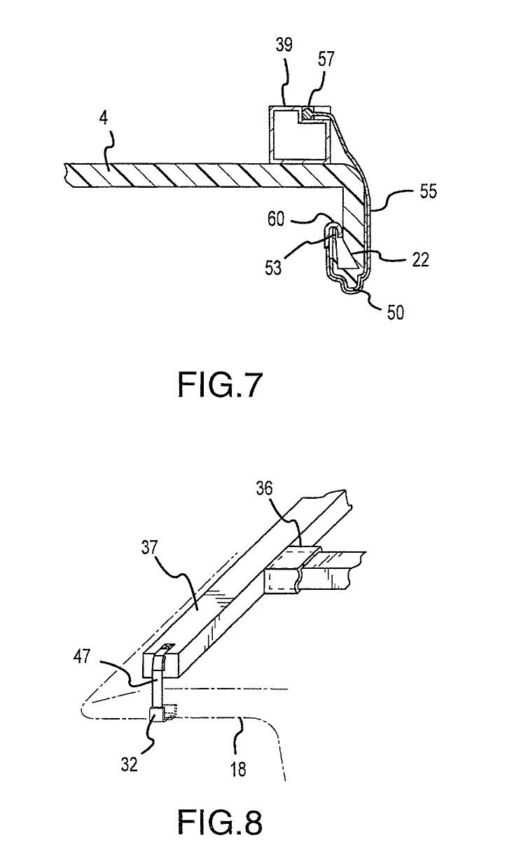

The rear portion of the hardtop 2 is grasped by a single elongated anchor tray 50 whose “J” like cross section (See FIG. 7) is also made to substantially conform to the exterior profile of the down turned rear edge 22 of the top 4. The tray comprises a bottom with upturned projecting sides and is hung by a pair of spaced apart straps 55 and 56 that attach to the lateral ends of the rear cross arm 39 by clasps 57 and 59. The distal ends of the straps 55 and 56 may be attached to the tray 50 by any number of means. However, in many vehicles the down turned edge 22 incorporates an upstanding lip 53 on the interior side of the edge 22 and this lip provides an additional means for securing the rear anchor tray 50 to the down turned edge 22. In order to insure the grasp of the tray 50 with the edge 22, the straps 55 and 56 depending from their respective clasps 57 and 59 wrap around the bottom and upstanding front and rear edges of the tray 50 and hooks 60, attached to the ends of each of the straps 55 and 56, are slung over the interior lip 53, as shown in FIG. 7.

The clasps 57 and 59 that attach the proximal ends of straps 55 and 56 to the rear cross arm 39 may be of any variety of known interconnections. Preferably, however, the clasps each include a “T” shaped member, the stem of which is attached to the strap. The cross member of the “T” is disposed within an elongated recess 62 in the top surface of the pallet's rear cross arm 39 with a interconnected perpendicular recess 64 to accommodate the top portion of the stem of the “T”. Such a connection makes it possible to quickly disconnect the tray 50 from the pallet for storage.

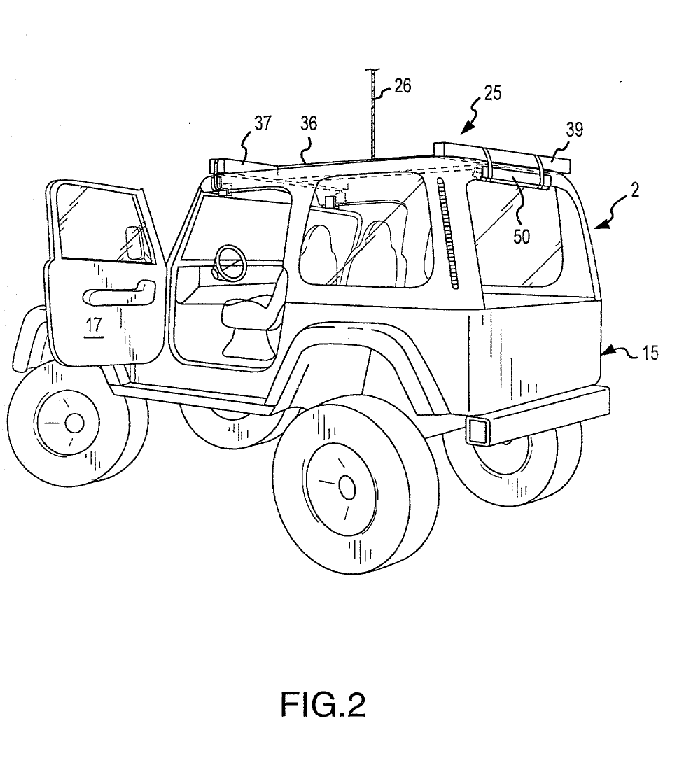

In operation, the vehicle is positioned centrally beneath the handling yoke 25, as shown in FIG. 1. The side windows 12 and 14 are lowered to their down position and the rear window glass or plastic, if any, is removed. The Yoke is lowered to the position over the vehicle's removable top shown in FIG. 2. The side anchors 32 and 33 are placed under the left and right upper window edges 18, also as shown in FIG. 2. The rear tray 50 is placed under the edge 22 and the hooks 60 are made to engage the interior lip, if any, on the interior of the down turned edge 22 of the top 4, as shown in FIGS. 6 and 8.

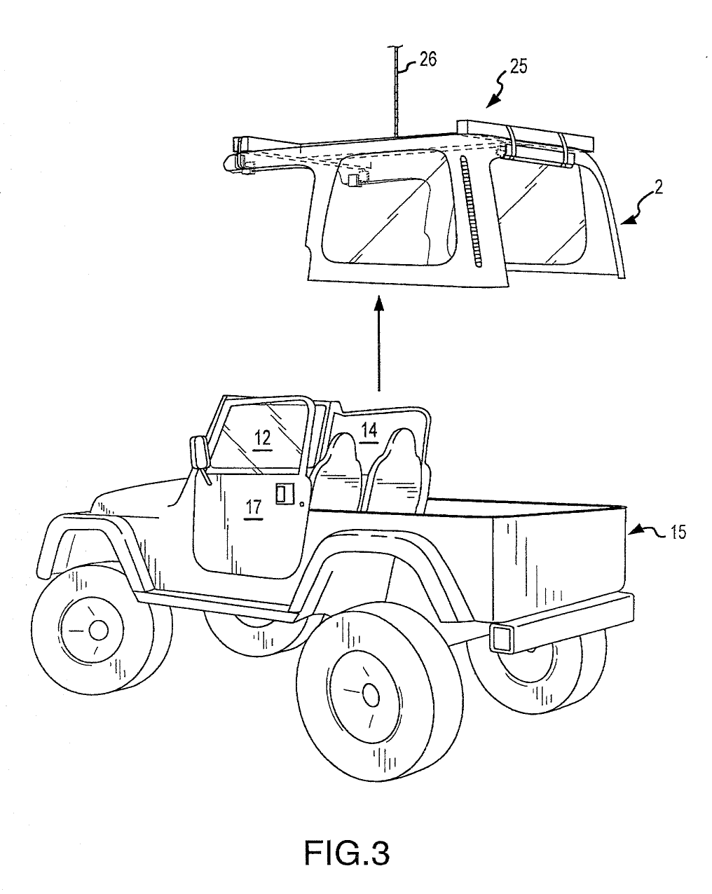

With the two side anchors and the one rear anchor having been located at their respective positions on the hardtop 2, and the interconnections between the hardtop and the vehicles having been released, the hoist is activated to raise the hardtop off of the vehicle, as shown in FIG. 3. The hardtop 2 can be stored in its elevated position, being very adequately retained by the handling yoke. When it is desired to replace the hardtop on the vehicle a reverse operation is done. In all phases of the operation, including removal, storage and replacement, the yoke 25 securely holds the hardtop with good stability and equilibrium.

In order to expand the range of hardtops to which the yoke will apply, the length of the spine 36 may be made adjustable and the shape of the anchors may be modified to more precisely fit the profile of the depending edges of the top being handled.

What is claimed is:

1. A handling yoke for clasping a removable vehicular hardtop, comprising,
(a) a rigid elongated spinal member,
(b) front and rear spaced apart cross members each having first and second ends and each being perpendicularly attached to the spinal member,
(c) an anchor depending from each of the first and second ends of the front cross member,
(d) an elongated anchor tray, and
(e) flexible means interconnecting the tray and the rear cross member.

2. The yoke of claim 1 where the elongated anchor tray is substantially “J” shaped in its lateral cross section.

3. The yoke of claim 1 where the flexible interconnecting means includes,
(a) at least one strap having first and second ends,
(b) a hook carried by the second end of the strap, and
(c) clasp means connected to the first end of the strap.

4. The yoke of claim 3 and further including,
(a) at least one recess in the rear cross member, and where the clasp means connected to the first end of the strap comprises a “T” shaped fastener, sized and adapted to fit within the receptacle in the rear cross member.

5. The yoke of claim 4 where the anchor tray comprises a bottom portion with upstanding front and rear sides and where the at least one strap is disposed to wrap around the front and back sides and bottom of the tray.

6. The yoke of claim 1 where at least one of the front and rear cross members is detachably secured to the spinal member.

7. A handling yoke for removing and replacing the hardtop of a vehicle, comprising,
(a) a rigid hanger pallet having longitudinal and lateral members,
(b) means integral with the pallet for attaching the pallet to a hoist mechanism,
(c) anchor means flexibly depending from the lateral members of the pallet for attachment to the hardtop.
